(19) United States
(12) Patent Application Publication
(10) Pub. No.: US 2003/0071004 A1
(43) Pub. Date: Apr. 17, 2003

(54) Extensible column

(76) Inventor: David J. Higgins, Resaca, GA (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/094,443

(22) Filed: Mar. 8, 2002

Related U.S. Application Data
(60) Provisional application No. 60/329,233, filed on Oct. 12, 2001.

(51) Int. Cl. B66C 23/62

(52) U.S. Cl. 212/292; 212/296

(57) ABSTRACT

A multi-sectioned, telescopically extending column. This invention includes an extension mechanism to extend the column and support the column sections during extension, and a locking mechanism to lock each column section to the next when the column reaches its extended position. The column is particularly well suited for use as a crane boom, where individual boom sections are nearly fully extended each from within the other to minimize overlap between adjacent sections and reduce dead weight resulting from such overlap.

### CROSS-REFERENCE TO RELATED APPLICATIONS

This application claims the benefit of U.S. Provisional Patent Application Serial No. 60/329,233, filed Oct. 12, 2001, which is hereby incorporated by reference herein for all purposes.

### FIELD OF THE INVENTION

The present invention is generally directed to an extensible column, and more particularly to a multi-sectioned, telescopically extending column for use in elevated lifting, support or structures.

### BACKGROUND OF THE INVENTION

Extensible columns find use in a number of applications, such as telescoping crane booms, telescoping sail towers, antenna supports, wind-power generating structures, and the like. One example application of an extensible column is a telescoping boom for a mobile crane. Mobile cranes are lifting machines, capable of being moved around or between work sites. Manufacturers and users of the mobile crane typically balance certain criteria when selecting a crane, such as total machine weight, cost, mobility, boom length and the net load lifting capacity of the machine. For instance, as a boom is designed to be longer or stronger, it normally must be made heavier. The heavier boom requires a heavier, more expensive, less mobile structure to support it. Significant advantage can be achieved by use of a strong but light boom which is easy to mobilize and capable of achieving longer telescoping ranges while maintaining rigidity of the boom under load.

U.S. patent application Ser. Nos. 09/819,498, filed Mar. 28, 2001, 60/192,518, filed Mar. 28, 2000, and 60/268,182, filed Feb. 13, 2001, which are hereby incorporated herein by reference in their entirety, show an improved telescoping crane boom, having minimal overlap between boom sections when the boom is in its extended position. This results in significant overall weight reduction in the crane. The structure disclosed for supporting the sections as they are being extended or retracted is external, requiring several large parts and careful pressure metering to make it work well. The arms, which support the boom as it is extending, have a tendency of building significant pressure on the boom section case walls. Since it is advantageous from a weight standpoint to make these walls thin, there is a limit in the pressure the walls can withstand. Also, the latching mechanism includes a multitude of pins, which engage in closely matched holes. Since these holes must be slightly oversized to facilitate ease of engagement, a slight amount of sag may result in the extended boom. The boom will support a greater load if it is straighter, especially at greater lengths. Although the boom cranes described in these applications represent significant advances in crane technology, continuous improvement is sought.

Thus it can be seen that needs still exist for improved extensible columns, and more particularly for improved telescoping crane booms. It is to these and other needs that the present invention is primarily directed.

### SUMMARY OF THE INVENTION

The present invention is directed to an extensible column, preferably a multi-sectioned, telescopically extending column. Various aspects of the invention furnish a structure to extend the column, support the column sections while the column is being extended, and lock each column section to the next when the column reaches its extended position. This invention works particularly well with a mobile crane, where the individual boom sections are nearly fully extended each from within the other.

One aspect of the present invention is an extension mechanism slidably positioned on a track, preferably situated inside the nested column sections, to affect support, extension, and latching of the extending column sections. Support of the column sections during extension is preferably accomplished using one or more latches mounted on the extension mechanism. These latches are arranged to engage a base collar of a column section and provide support about at least two axes perpendicular to the longitudinal axis of the column as it extends, thereby positioning and maintaining the column section in alignment with that column section within which it is nested. Once in the extended position, a locking mechanism is actuated to lock or latch the column sections together, again the sections are locked together against free motion about at least two axis. Thus, the extension mechanism of the present invention preferably maintains the sections in axial alignment during extension of the column, resisting any out-of-axis forces and bending moments, even when the column is extended under load.

Another aspect of the present invention is a telescoping column. The column preferably includes a first column section with proximal and distal ends, the distal end having a tip collar. The column preferably also includes a second column section telescopingly coupled to the first column section and movable between a retracted position and an extended position. The second column section preferably includes proximal and distal ends, the proximal end having a base collar. The tip collar and the base collar are preferably releasably engageable with one another to lock the second column section in its extended position.

Yet another aspect of the invention is a telescoping column, preferably including a first column section and a second column section telescopingly coupled to the first column section and movable between a retracted position and an extended position. Preferably, the first and second column sections overlap in the extended position by a distance less than a major cross sectional dimension of the column.

Another aspect of the invention is a telescoping column, preferably including a first column section and a second column section telescopingly coupled to the first column section and movable between a retracted position and an extended position, wherein the first and second column sections define a support angle greater than 45° in the extended position.

Still another aspect of the invention is locking mechanism for locking adjacent sections of a telescoping column in position relative to one another. The locking mechanism preferably includes a female locking ring having an irregular inner contour, and a male locking ring having an irregular outer contour, wherein the irregular outer contour of the male locking ring can pass at least partially through the irregular inner contour of the female locking ring in an aligned configuration, but wherein the irregular outer contour of the male locking ring can not be retracted from the irregular inner contour of the female locking ring in an unaligned configuration. At least one of the male and female locking rings preferably moves between the aligned configuration and the unaligned configuration.

Another aspect of the invention is an extension mechanism for moving a telescoping section of a column between a retracted position and an extended position. The extension mechanism preferably includes a track mounted within the column, and a carriage translationally mounted to the track and movable between a loading position and a locking position. The extension mechanism preferably also includes a latch mounted to the carriage, the latch being arranged to engage the telescoping section so as to support the section in axial alignment during extension.

Yet another aspect of the invention is a method of locking first and second sections of a telescoping column in a fixed position relative to one another. The method of the invention preferably includes aligning a first locking element of the first section with a cooperating second locking element of the second section, positioning the first and second sections in a desired position relative to one another, and moving the first locking element out of alignment with the second locking element to prevent relative movement between the first and second sections.

In another aspect, the invention is a crane. The crane of the present invention preferably includes a support base and a telescoping column having a first column section mounted to the support base and at least one telescoping column section telescopingly coupled to the first column section. The crane preferably also includes an extension mechanism having a track within the column, a carriage translationally mounted to the track, and at least one latch pivotally mounted to the carriage for engaging a portion of the at least one telescoping column section. The crane preferably also includes a locking mechanism having a first locking ring mounted to the first column section and having an irregular inner contour, and a second locking ring mounted to the telescoping column section and having an irregular outer contour.

These and other aspects, features and advantages of the present invention will be better understood with reference to the following detailed description and appended drawings of exemplary embodiments.

### BRIEF DESCRIPTION OF THE DRAWINGS

As used herein, like numerals throughout the various figures represent the same or equivalent features of the present invention.

FIG. 1 is a side view of a telescoping boom crane according to one embodiment of the present invention.

FIG. 2 is a side view of an alternative crane according to another embodiment of the present invention.

FIGS. 3a, 3b and 3c depict a crawler type telescoping boom crane according to another embodiment of the present invention.

FIG. 4 shows a multiple column embodiment of the present invention.

FIG. 5 shows an extensible column supporting telecommunications antennae, according to another embodiment of the invention.

FIG. 6 shows an extensible column supporting a wind power generating airfoil, according to another embodiment of the invention.

FIGS. 7a and 7b are partially cut-away side views of the operation of an extension mechanism for extending or retracting boom sections according to one embodiment of the present invention.

FIG. 8 is a cross-sectional side view of the extension mechanism according to the embodiment of the present invention shown in FIG. 3.

FIG. 9 is a side view of FIG. 4 taken along line 9-9, in partial cross-sectional view.

FIGS. 10a-10c are cross-sectional side views of an extension mechanism according to another embodiment of the present invention.

FIG. 11 is a partial perspective view of a latch according to one embodiment of the present invention.

FIGS. 12a-12c are cross-sectional top views of a boom section shown in unlocked and locking engagement taken along line 12-12 according to FIG. 2.

FIG. 13 is a partial exploded perspective view of a locking ring according to one embodiment of the present invention.

FIG. 14 is a perspective view of a tip collar according to one embodiment of the present invention.

FIG. 15 is a cross-sectional side view of an extension mechanism according to another embodiment of the present invention.

FIGS. 16a and 16b show an extension mechanism according to another embodiment of the present invention.

FIGS. 17a and 17b show cross-sectional views of overlapping portions of adjacent boom sections of a prior art telescoping boom and a boom according to a preferred form of the present invention.

### DETAILED DESCRIPTION OF PREFERRED EMBODIMENTS

Referring now in greater detail to the drawing figures, the depicted embodiments of the present invention include a telescoping tower crane, heavy-lift crane boom chords, a crawler mounted crane with a rope luffed boom, variations of telescoping boom cranes, components thereof and various improvements thereto, including methods and apparatus for extending, supporting during extension, and locking boom sections of a telescoping column. In one aspect, the present invention is a telescoping boom crane having a multi-sectioned, telescopically extending boom, similar to those typically used in a mobile crane. Various forms of the present invention are also useful for mobile load supporting towers, tower cranes, mobile construction cranes, crawler cranes and the like, or parts thereof, including the jib, mast, boom, boom extension, derrick, counter boom, counter jib and the like. The present invention is also particularly well suited for use in extensible chords of very large heavy-lift crane booms and counter booms. (As used herein, when the components are described as “extensible”, it will be understood that the components are also retractable).

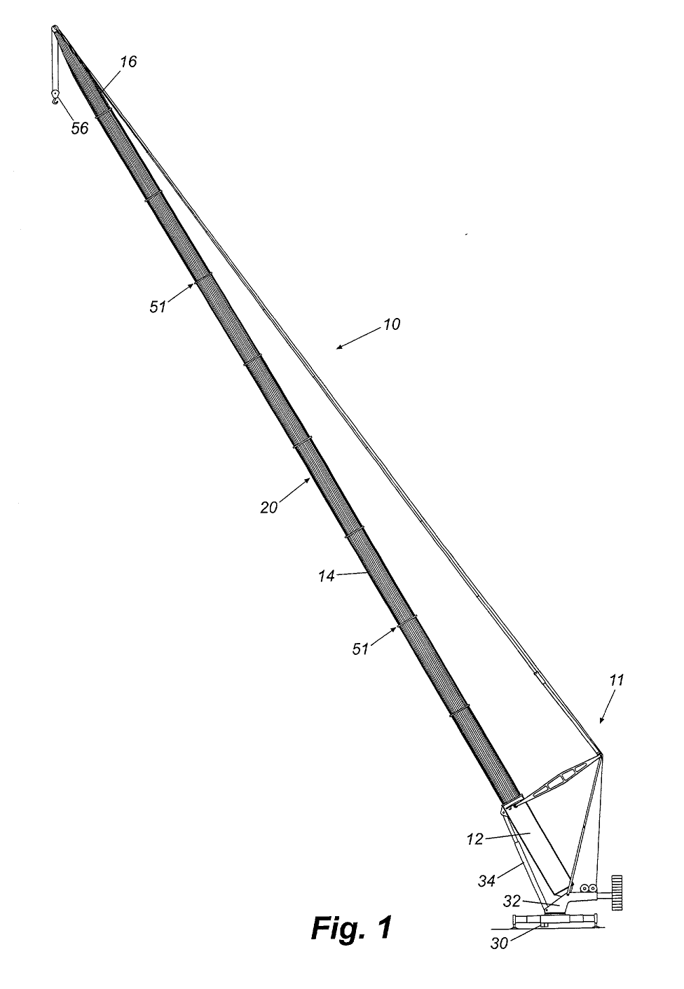

With reference to FIG. 1, a telescoping boom crane 10 according to one embodiment of the present invention includes a multi-sectioned, telescopically extending boom 20. The boom 20 typically has a hoisting device 56, such as a hook block, at one end, and a base or support structure 32 at the other end of the boom. Of the multiple boom sections, the telescopically extending boom 20 includes a base boom section 12 that is not extensible, and a tip boom section 16. The base boom section 12 is typically mounted to a structural frame 32 and a base boom hoist cylinder 34.

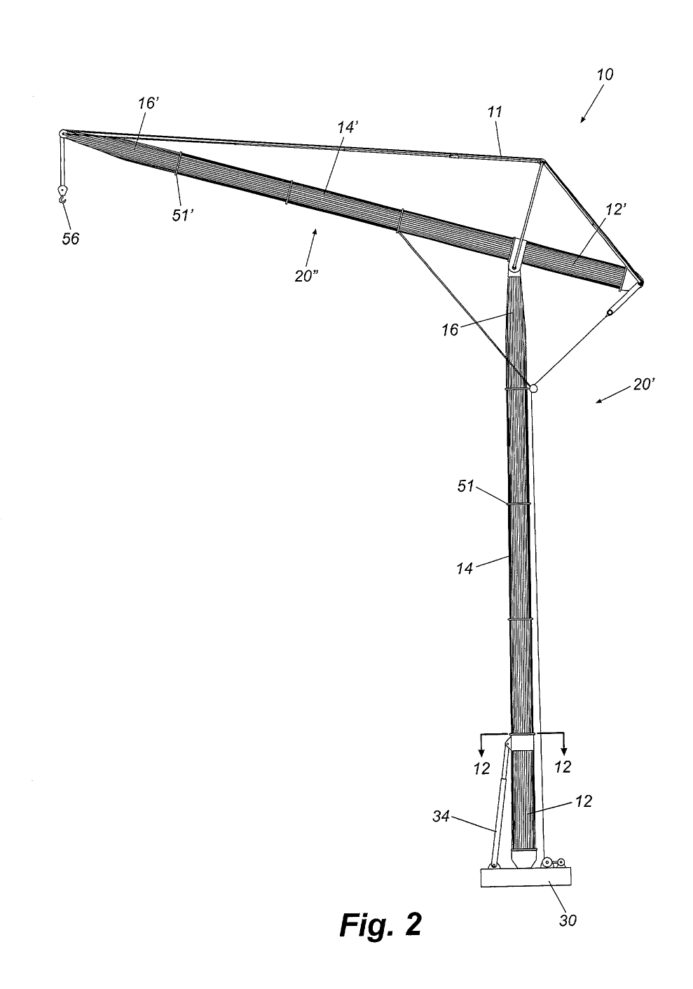

Similarly, FIG. 2 depicts a telescoping crane 10 as a tower crane embodiment, wherein a vertical column 20′ and a substantially horizontal boom section 20″ include substantially the same components as those described for the boom 20 of the crane of FIG. 1.

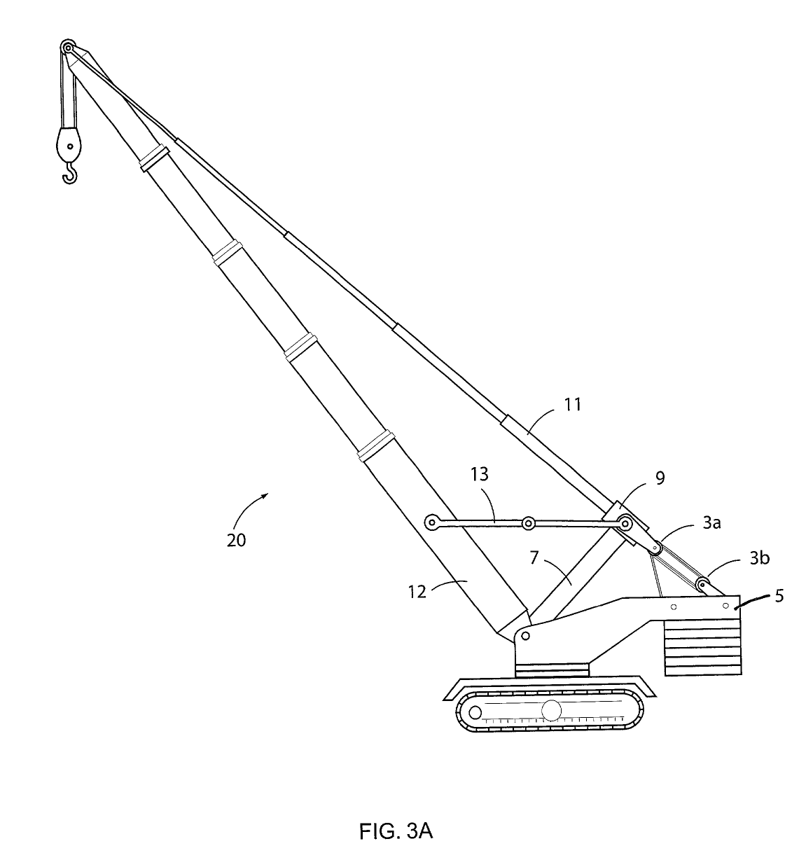

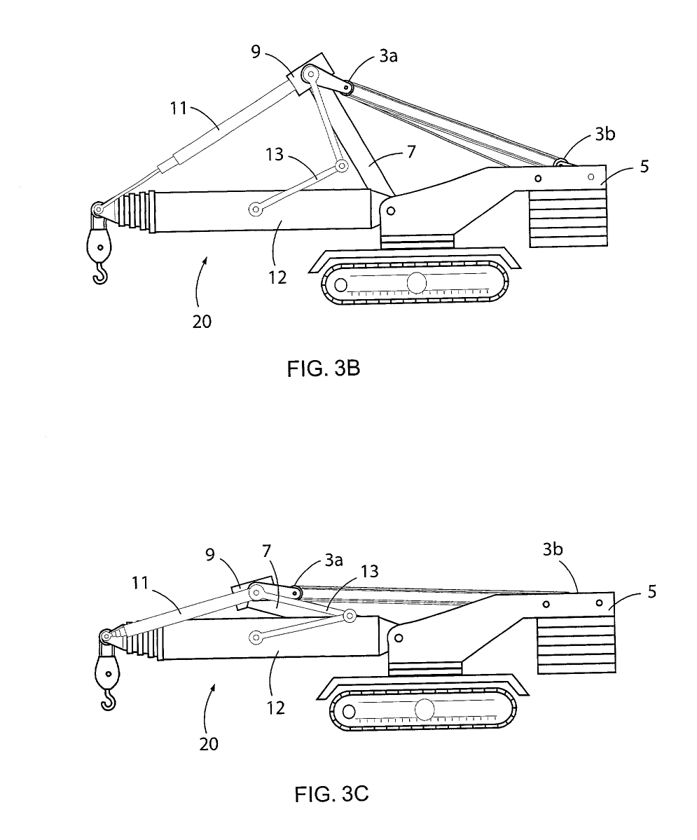

FIGS. 3a, 3b and 3c depict a crawler crane fitted with a telescoping boom 20 according to a preferred form of the invention, shown in extended, partially retracted, and fully retracted (stowed) positions, respectively. The boom 20 is preferably supported and luffed by wire rope bails 3a, 3b attached at the near end to a rotating superstructure 5 and at the distal end to a folding mast 7 and pendant forestay sleeve 9. An extensible forestay 11 is engaged slidably within sleeve 9 and supports boom 20 from the distal end, thereby transferring most external loads placed upon boom 20 into axial compressive loads centered upon the longitudinal axis of the boom 20. Folding forestay 13 supports base boom 12 during operation of the present invention in the extension or retraction of telescoping boom 20. When the boom 20 of the present is completely retracted, the supporting/luffing components are preferably compactly stowed beside the boom, as seen with reference to FIG. 3c.

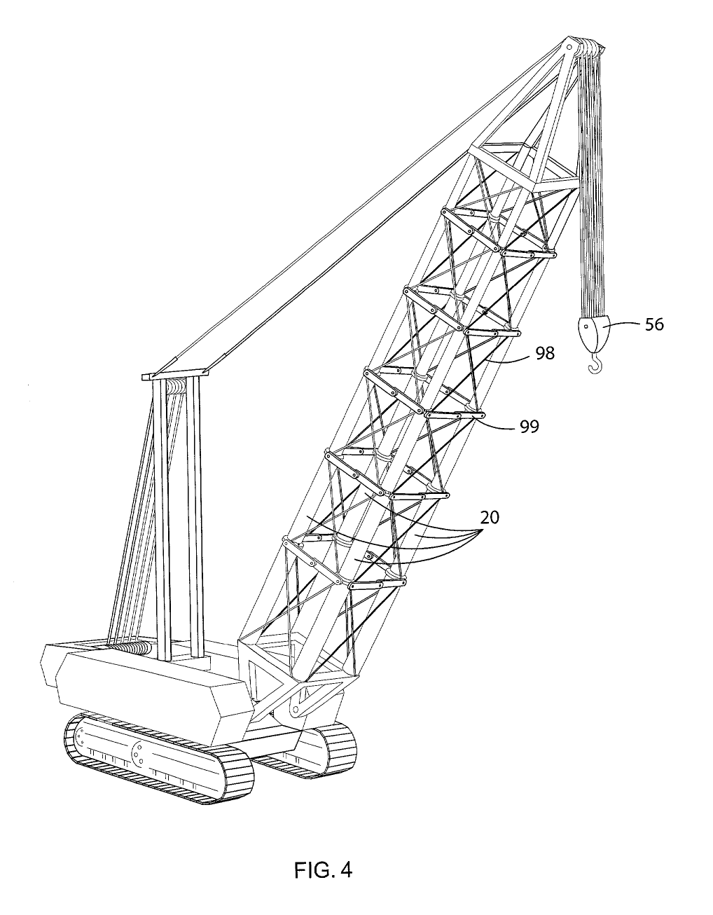

FIG. 4 depicts a very large heavy lift crane according to another embodiment of the present invention. This crane is designed to be transported packed inside a number of standard overseas shipping containers. The boom of this crane preferably comprises two or more (four are depicted) extensible columns 20, each column 20 comprising one chord of the boom. Folding perpendicular struts 99 and flexible lacing 98 interconnect and brace the multiple columns 20 of the boom. The folding and flexible elements 99, 98 preferably remain attached to the columns 20 during extension and retraction, and stow compactly alongside the columns for shipment. The main length of the boom can thereby be quickly retracted and folded compactly, preferably fitting inside a standard 40′ shipping container. A tapered base 21 and tapered tip 23 are preferably sized and configured to be detached from the main length and shipped in separate containers.

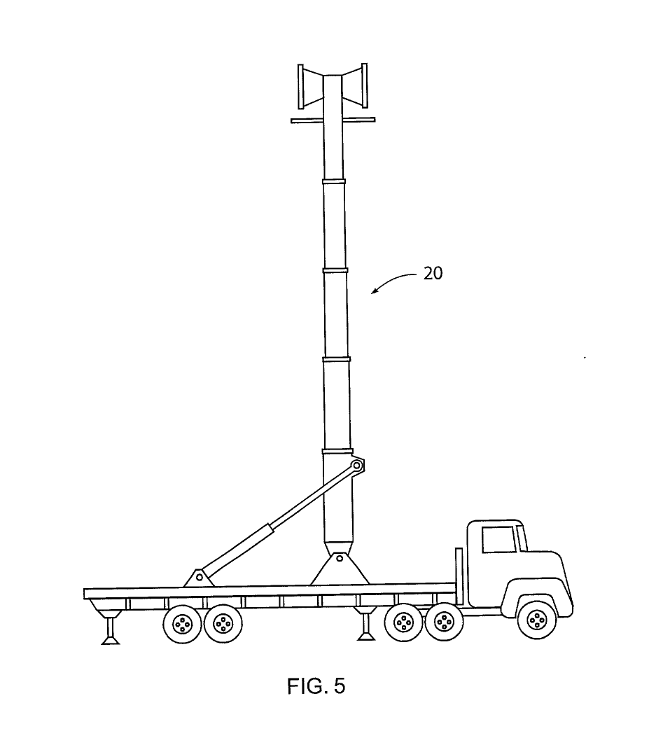

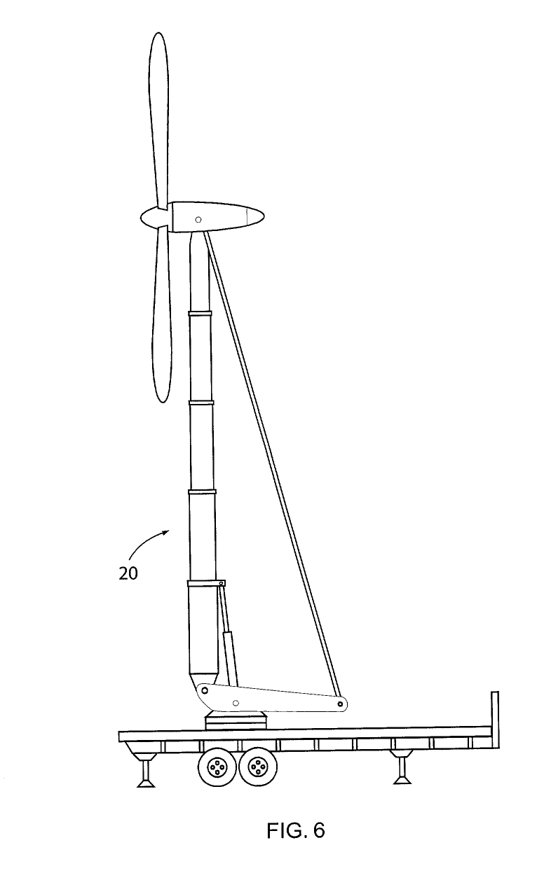

FIG. 5 shows a trailer mounted tower comprising the extensible column 20 of the present invention outfitted with antennas for tele-com use. FIG. 6 depicts another trailer mounted tower, this one supported by a tensile forestay countered by a hydraulic cylinder. This extensible tower is fitted with a substantial twin-blade airfoil and a top mounted generator. It is useful for temporary or permanent installation in wind fields as an electrical power generator. When mass produced this mobile tower comprising the present invention is competitive with typical site-built towers, it is easier to transport and it is readily retractable for servicing, updating or moving to another location.

The present invention expedites erection of self-supporting telescoping towers and extensible load-bearing columns as well as telescoping crane booms. Except as otherwise indicated, in the subsequent discussion the terms ‘boom’, ‘tower’, and ‘column’ may be considered to be synonymous in terms of the present invention. The present invention is well-suited to telescoping crane booms where it is preferably used in conjunction with a crane pendant system 11, most preferably an extensible pendant system such as that described in U.S. patent application Ser. No. 09/819,498, incorporated herein by reference, for minimizing or eliminating bending forces in the boom and thus making the boom substantially a column designed to be loaded mainly with compressive force directed along the longitudinal axis.

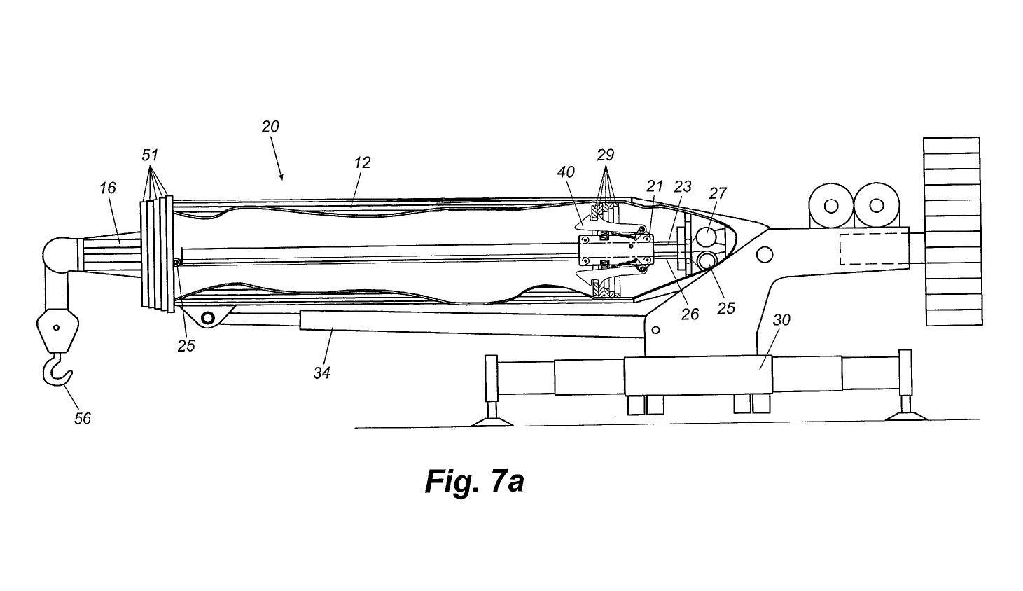

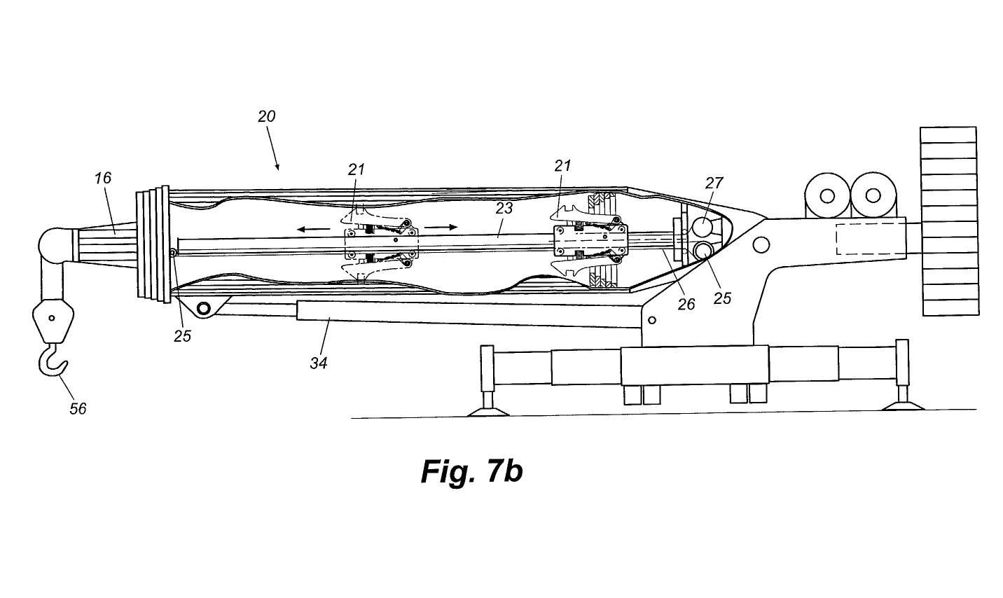

Returning now to FIGS. 1 and 2 for a more detailed discussion of example embodiments of the present invention; the telescopically extending boom 20 and/or the extensible tower 20″ may include at least one intermediate boom/tower section 14. Each of the intermediate sections has a tip collar 51 and a base collar 29. Likewise, the tip section has a base collar and the base section has a tip collar. (See, for instance, FIGS. 2 and 7). The tip section 16, and each of the intermediate sections 14 when present, is extensibly receivable within its adjacent section. In order that each adjacent section be capable of nesting within or being extensibly receivable within its adjacent section, it is preferable that each section have a smaller cross section than its adjacent section.

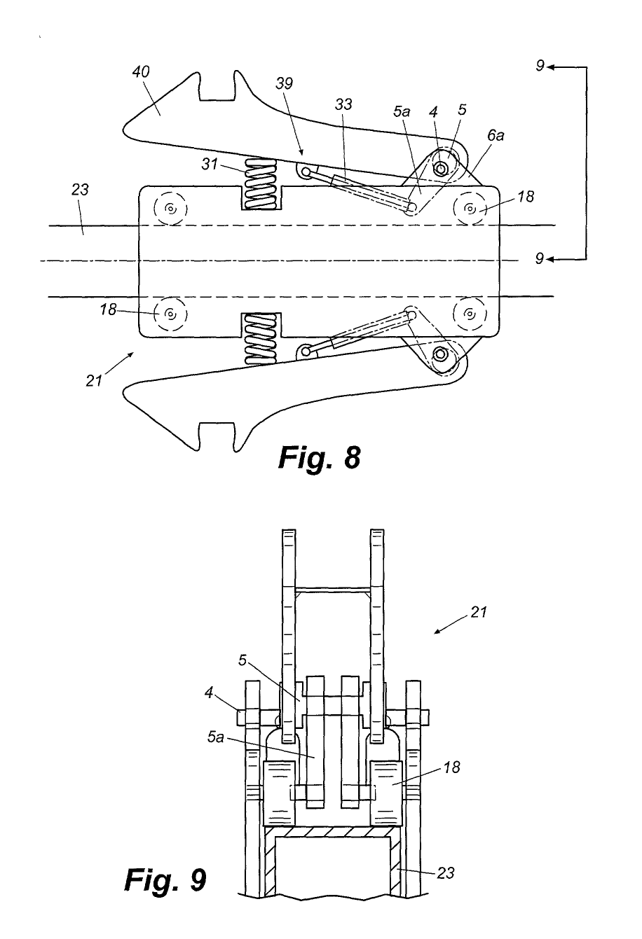

According to one aspect of the present invention, the column sections are boom sections and they are extended by an extension mechanism 21, (such as a power driven trolley or carriage), as shown for example in FIGS. 7a-7b. Typically, a track 23, such as a beam, channel, or tube, is attached at tip and/or base of the base boom section 12, and extends within the interior of the boom sections. The extension mechanism 21 is slidably mounted to the track 23. The extension mechanism 21 may travel along track 23 using, for instance, rollers 18 as shown by way of example embodiments in FIGS. 8-10. Embodiments of the extension mechanism 21 are configured so as to grasp the base collar 29 of the intermediate boom section 14 or the tip boom section 16, so as to extend and/or retract each boom section within the base boom section.

One such configuration for slidably moving the extension mechanism 21 along the track 23 includes using a winding device 25, such as a pair of sprockets, drums or cylinders, (e.g. a hoist or winch), around which a linking mechanism 26, such as a roller chain, rope, wire, or cable, is connected to the extension mechanism 21. As the extension mechanism 21 travels toward the base end of the base boom section 12, the mechanism is activated to grasp the base collar 29 of the next sequential boom section. Likewise, as the extension mechanism travels to the distal end of the base boom section 12, the boom section thus grabbed is thereby extended. Once in the extended position, the locking mechanism will be activated to lock the boom in position as described more fully below. The winding device 25, at the base end of the beam, is typically powered by a suitable gear motor and brake to effect movement of the extension mechanism 21. In alternate embodiments, the extension mechanism comprises one or more hydraulic or pneumatic cylinders, and/or other fluid-driven, motor-driven, mechanical, and/or electromagnetic drive means. For example, the extension mechanism 21 can alternatively be driven by a hydraulic cylinder or can even be mounted on a moving part of a hydraulic cylinder. A reel can be provided for stowage of any necessary hydraulic and electrical lines to operate the extension mechanism.

In alternate embodiments of the invention, the extension mechanism may be selectively operated to grasp the second or even thirdly available nested boom section—thereby extending various multiples of nested boom sections as one. Referring to FIG. 3a, boom 20 has been erected by grasping and extending two sections at a time, leaving every other boom section retracted, thereby providing a shortened boom having approximately twice the compressive strength of the fully extended boom. Alternatively, only selected sections, such as the base sections, are left retracted for double or other multiple thickness support.

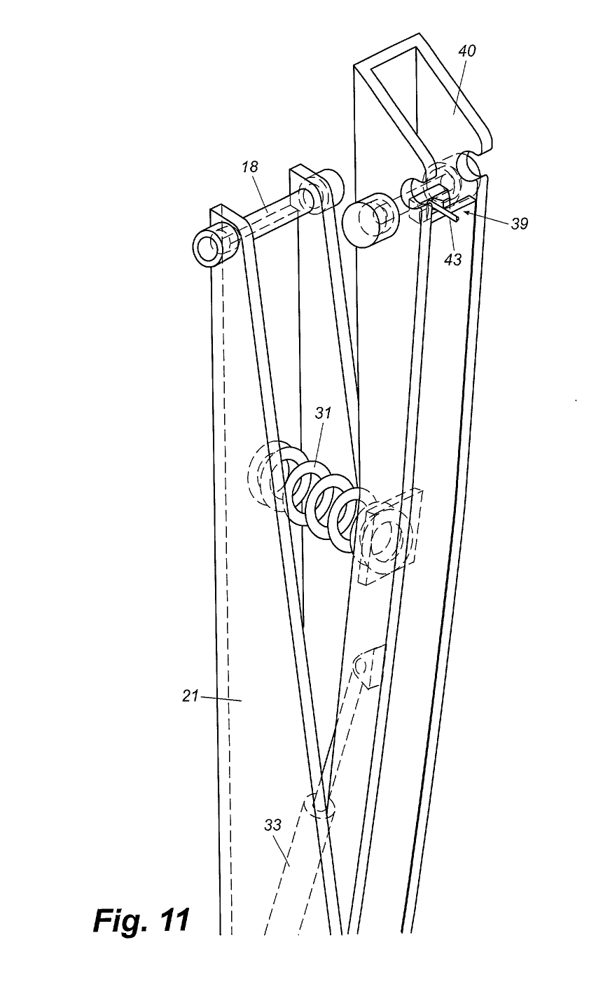

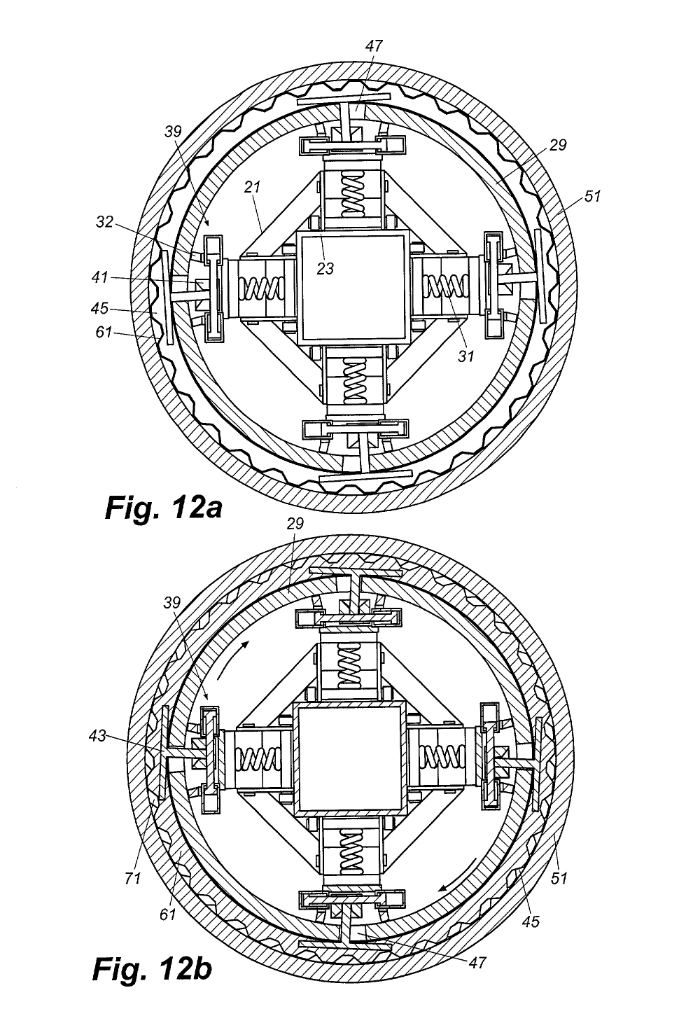

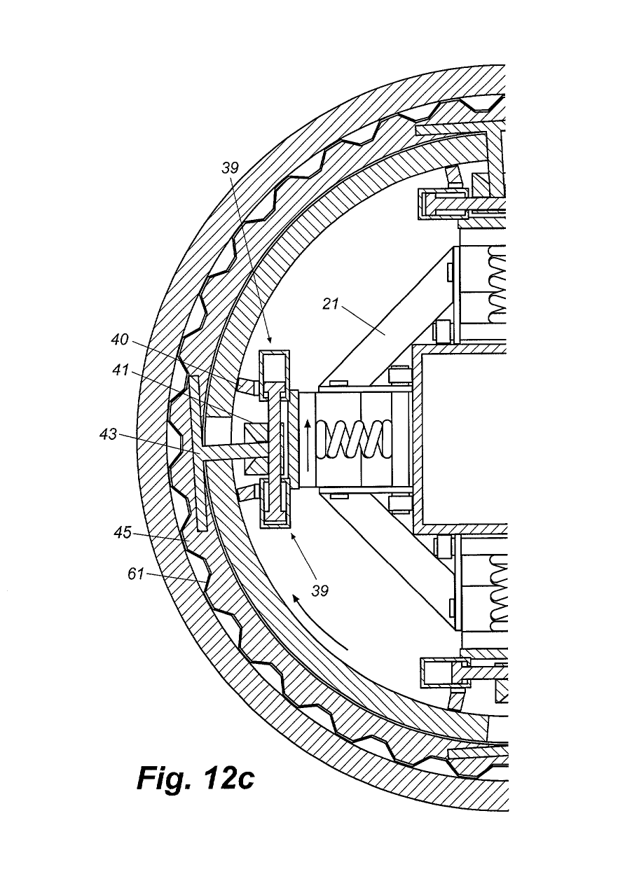

Referring more specifically to FIGS. 8, 10 and 11, example embodiments of the extension mechanism 21 are typically equipped with one or more latch(es) 40 made to engage the base collar 29 of any boom section. In one form of the invention, a spring 31 urges the latch(es) 40 into latching engagement with the base collar 29. In an exemplary embodiment according to the present invention, four latches 40 are situated at right angles to one another around the track 23 as shown, for instance, in FIGS. 12a-c. With reference now to FIG. 8, the latch(es) 40 are preferably pivotally attached to the extension mechanism 21 at pivot point 5. A repositioning mechanism 33, such as a hydraulic cylinder, serves two functions. When the latch(es) 40 are engaged with a base collar 29, the repositioning mechanism 33 causes a member 5a to rotate a camshaft 4 with a high force. The camshaft 4 typically is a shaft, machined so as to have at least one set of smooth, round bearing surfaces slightly offset from the shaft center. These offset bearing surfaces are engaged in bushings 5, which fit into openings in the latch(es) 40. As the camshaft 4 turns, the latch(es) 40 rotate about the shaft centerline. Even slight rotation of the camshaft 4 in the bushing 5 causes the latch(es) 40 to move toward the base of the boom. This movement preloads the latches 40 against the base collar 29, actually tilting the extending boom sections up against the force of gravity and thus facilitating both extension through and alignment with the adjacent boom section tip collar. The latches 40, therefore, are able to approach each base collar 29 at the angle necessary to grasp the collar, and then move to take up any slack in the engagement area. Further, the latches 40 actually support the base collar 29 while engaged such that rotation of the extending boom section(s) perpendicular to the base boom section's longitudinal axis caused by gravity and/or wind, is minimized, thereby more nearly aligning the boom section collars during the locking or latching operation. Provision of two pairs of latches 40 arranged at right angles to one another resists deflection of the boom about any axis perpendicular to the boom's longitudinal axis, effectively locking the boom against downward sagging under the force of gravity and against sideways wind deflection. For instance, a first pair of latches supports the telescoping section against rotation about a first axis perpendicular to the longitudinal axis, and a second pair of latches supports the section against rotation about a second axis perpendicular to both the longitudinal axis and the first axis. By engaging the boom sections in this manner, the extension mechanism of the present invention supports the boom section during extension and retraction, and resists deflection out of alignment with the longitudinal axis of the boom, even when extended and retracted under load.

The repositioning mechanism 33 is also used to rotate the latch(es) 40 against the bias of spring 31 when necessary to disengage the extension mechanism 21 from one boom section in order to return along track 23 to pick up another boom section.

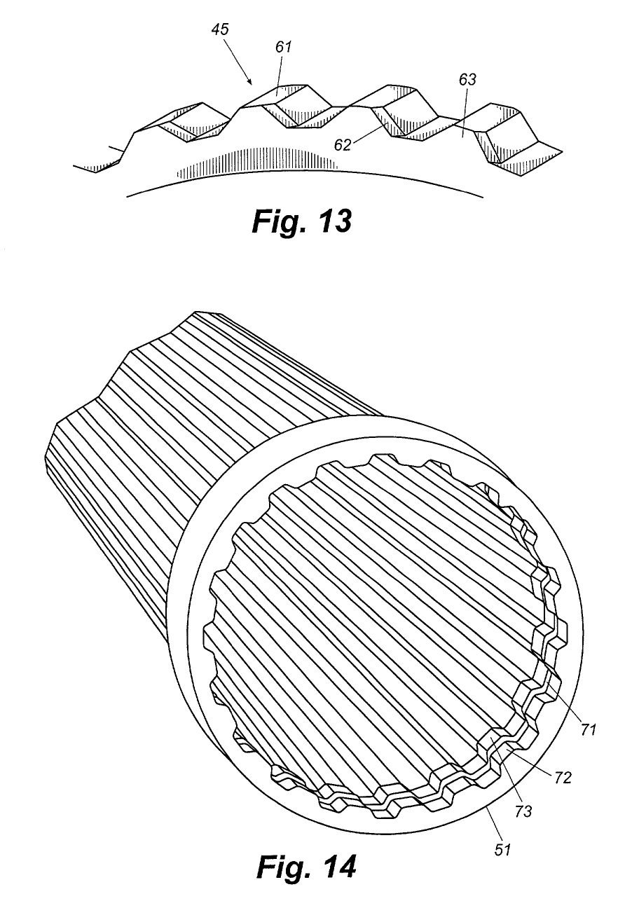

FIGS. 12a and 12b show cross-sectional cut-away views of the locking mechanism when the tip collar 51 of one boom section engages and interlocks with the base collar 29 of an adjacent boom section. FIG. 14 shows a typical tip collar 51 in perspective. The tip collar 51 includes walls 72 and 73, which flank a slotted area 71. As shown herein, walls 72 and 73 preferably comprise a scalloped or toothed inner contour, so as to closely match the overall interior contour of the boom section to which it is attached.

Turning again to FIG. 12, the base collar 29 features a locking ring 45 that is rotatably attached to the base collar 29. An exploded cutaway perspective view of the locking ring 45 is shown in FIG. 13. The outer contour of the locking ring 45 preferably closely matches the exterior contour of the column section to which it is mounted, and as shown herein comprises a scalloped or toothed outer contour, designed to interlock with the cooperating inner contour formed by walls 72 and 73 of the tip collar 51. When the base collar 29 is aligned with the tip collar 51, the locking ring 45 may be rotated so as to turn within the slotted area 71, thereby overlapping the teeth of locking ring 45 with the teeth formed by walls 72 and 73. The outer contour of the locking ring 45 preferably closely matches the exterior contour of the column section to which it is mounted, which is shown herein as a sheet material with lands embossed for greater axial compressive strength. With respect to the present invention a ring shaped to match a column cross-section delineated by virtually any closed polygonal shape can be arranged and actuated to effectively lock adjacent column sections together. For example, any irregular or eccentric configuration of locking ring 45 capable of engagement and disengagement with a cooperating configuration of the tip collar 51 can serve to lock and unlock adjacent boom sections.

An activation mechanism 39 is preferably arranged on latches 40 for locking and/or unlocking the locking ring 45 within the slotted area 71. The activation mechanism 39 is mounted on the latch(es) 40 and moves back and forth across the latch 40. With reference to FIGS. 12a-c, the activation mechanism includes a receiving member 41, shown herein as having a fluted recess. The receiving member 41 is arranged so as to receive a handle 43. The handle 43 is attached to the locking ring 45, and extends through a slot 47 within the base collar 29. When the activation mechanism 39 is aligned with the handle 43, the handle 43 will slip into the activation mechanism. Upon operation of the activation mechanism 39, the handle will shift the locking ring 45 into or out of locking engagement with the tip collar 51. In preferred form, the activation mechanism comprises a 2-directional hydraulic cylinder coupled to the receiving member 41 for moving the handle 43 when engaged therein. Alternatively, the activation mechanism comprises one or more hydraulic cylinders, pneumatic cylinder(s), solenoid(s), motors, and/or other drive mechanisms.

Each of the components of the locking mechanism may be made from various engineering materials, including, steel, other metals, polymers and the like. The locking ring 45 may be made from, for instance, a cast polyamide polymer. The inside of the locking ring 45 is typically round and smooth. The sides of the locking ring 45 are typically smooth so as to slide freely within slot 71. The teeth 61 formed to match the overall contour of the column section may be slightly tapered as shown, for instance, in FIG. 13.

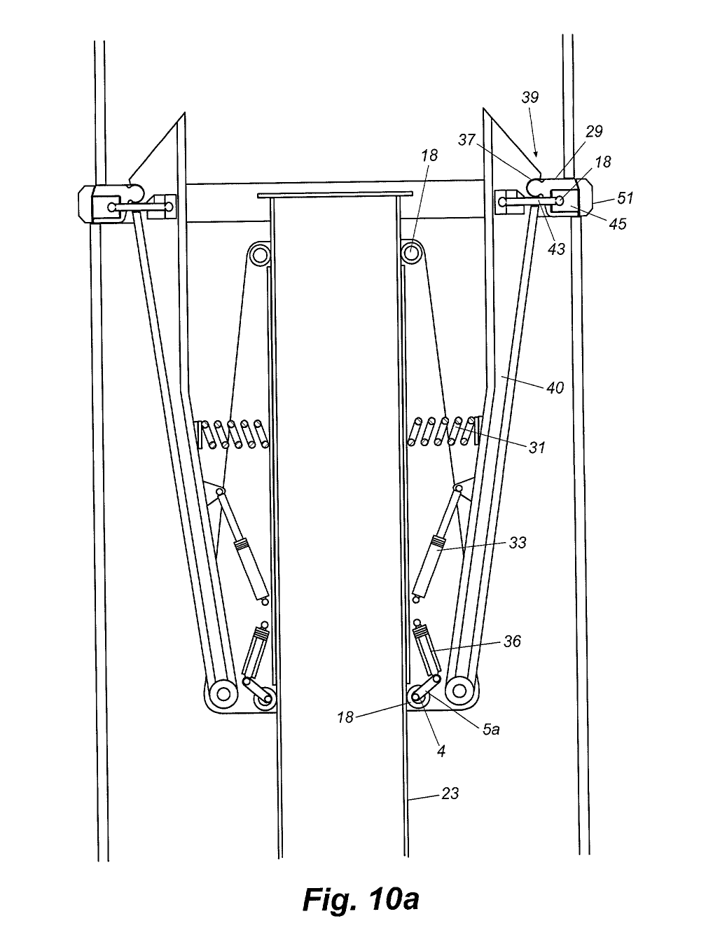

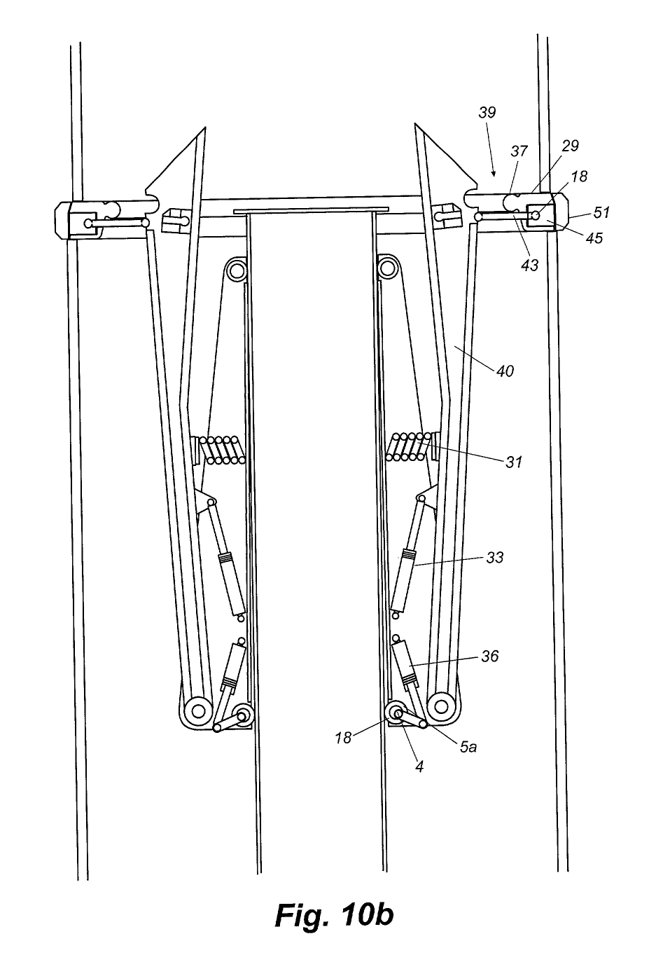

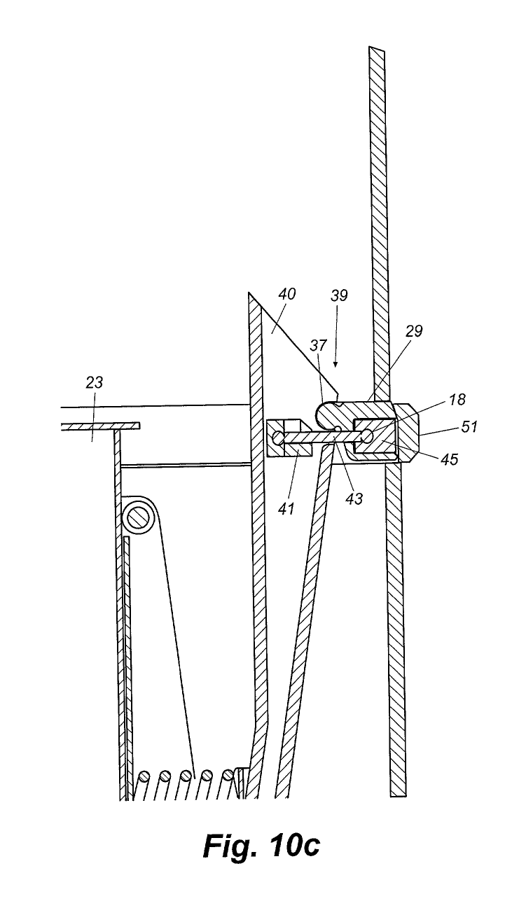

To lock the column sections together in an extended configuration, the extension mechanism 21 is engaged to grasp the base collar 29 of a column section, and is advanced until the base collar 29 slides within tip collar 51, bringing locking ring 45 into alignment with slot 71 of the tip collar 51, as seen for instance in FIGS. 10a and 10c. The activation mechanism 39 is actuated, urging the handle 43 clockwise along the slot 47 in the base collar 29 to the locked position, as seen for instance in FIG. 12b. The locking ring 45 is thus rotated, thereby sliding the teeth of the locking ring within the slot 71 of the tip collar 51. The positional relationship of the components are shown with the locking ring 45 released in FIG. 12a and engaged in FIG. 12b. The engaged or locking position, therefore, preferably consists of engaging flat and parallel surfaces 63 (FIG. 13) of the locking ring 45 into interlocking relationship with the teeth of walls 72 and 73 of the tip collar 51. Additionally, if the teeth 61 of the locking ring 45 include a tapered surface 62, the surface will assist in aligning the two column sections with respect to one another, thereby forcibly removing any slight misalignment that might occur during a high-speed column extending operation. Preferably, the width of the slot 71 is slightly less than the thickness of the locking ring 45. This results in a press fit every time the column is extended and at every joint in the extending column. Although the depicted embodiment includes a base collar having a locking ring portion that rotates to engage and disengage a stationary tip collar, the present invention also includes the reverse configuration wherein a locking ring rotationally mounted in a tip collar engages and disengages a slot in a base collar.

Each successive boom section 14, 16 is preferably extended from a retracted position at least partially within the base section 12 (shown in FIGS. 7a-7b) to an extended position at least partially beyond the base section (FIGS. 1, 2), and is locked in the extended position for use. The extension mechanism 21 traverses the track 23 to a loading position (shown in solid lines in FIG. 7b) to engage the base collar 29 of each successive boom section 14, 16. Once engaged, the extension mechanism 21 traverses the track 23 toward a locking position to move the boom section to its extended position, as indicated by the leftward arrow indicating travel of the extension mechanism shown in broken lines in FIG. 7b. The activation mechanism 39 moves the teeth of the locking ring 45 into alignment with cooperating spaces between the teeth of the tip collar 51 (FIG. 12a) to allow passage of the locking ring into the slot 71 between walls 72,73 of the tip collar 51. The activation mechanism 39 then rotates the teeth of the locking ring 45 within the slot 71, out of alignment with the spaces between the teeth of the tip collar 51 (FIG. 12b), whereby interference between the teeth of the locking ring 45 and the teeth of the tip collar 51 lock the boom section in its extended position. The extension mechanism 21 then disengages the base collar 29 and can be returned to the loading position to engage the next successive boom section for extension. Of course, it will be understood by one of ordinary skill in the art, that the above sequence for extending the boom sections can be reversed to retract the boom. Sensors are preferably placed at strategic locations to provide information on the position of the various components and most particularly to actuate the next step in the sequence required to extend or retract the column. Automatic operation can be accomplished using mechanical, electrical, and/or electronic sensors, controllers, and actuators, as will be understood by those of ordinary skill in the art.

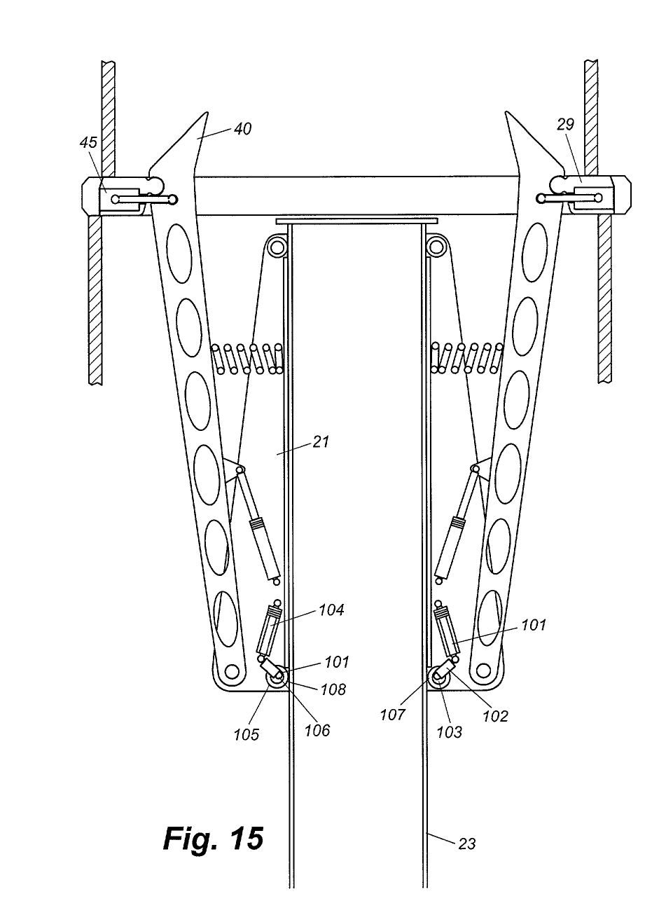

Another example embodiment of the extension mechanism of the present invention is shown in FIG. 15. Cylinders 104 provide the boom pre-load forces, facilitating alignment of the locking ring 45 with the slot 71. With the cylinder 104 extended as shown, an arm 105 rotates the camshaft 106. Camshaft 106 also serves as the axle for wheels 107. Rotation of the camshaft 106 urges the wheel 108 toward the track 23 forcibly tilting the extension mechanism 21 and latches 40 holding the base collar 29. Movement of the cylinder 101 is coordinated with movement of the cylinder 104, which moves in the opposite direction.

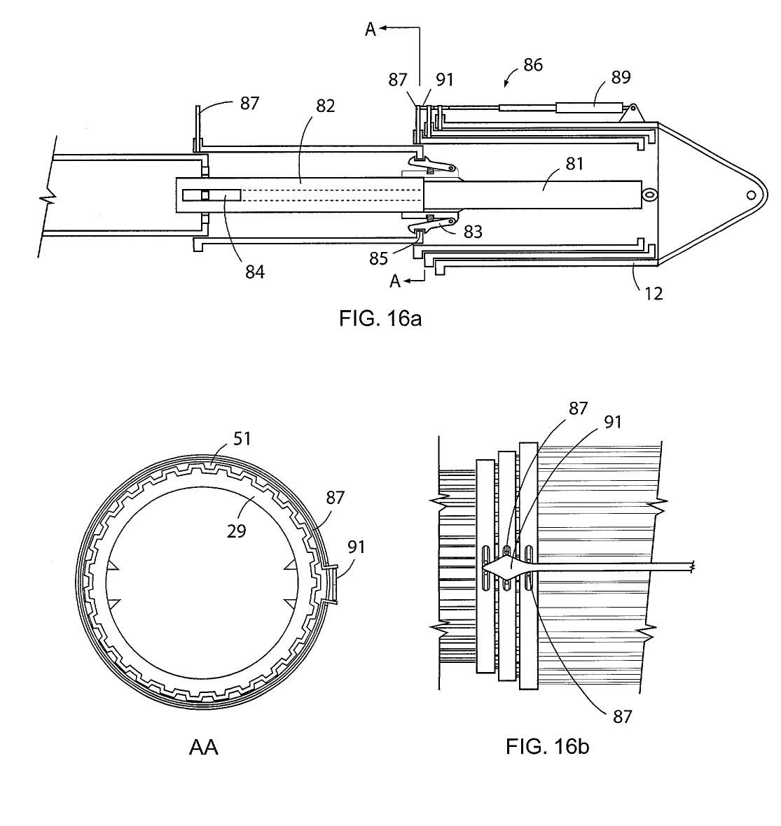

A further embodiment of the present invention is shown in FIGS. 16a and 16b. In this embodiment, a sliding beam 82 slides on a hydraulic cylinder 81. A set of latches 83 are pivotally attached to the sliding beam 82 and are equipped with a rectangular notch 85 arranged to engage the base boom section collar of the boom section being moved. Latches 83 are hinged to pivot about an axis parallel to the longitudinal axis of the boom section. They are preferably spring or compressed gas-loaded and hydraulic or air-retracted. Latches 84, are also pivotally attached to the beam 82, and engage the base collar of the last boom section moved. The boom section lock actuator 86 is preferably mounted externally in this embodiment of the present invention. Actuator 86 comprises a wedge 91 driven by a hydraulic cylinder 89. Referring to FIG. 16b, wedge 91 is moved toward the base boom section 12 to disengage from snap-ring 87 allowing it to snap into a cooperating groove in the base collar 29 of the adjacent boom section. In this manner, the snap-ring 87 engages both the base collar 29 and the tip collar 51 of adjacent boom sections, interfering with respective motion of the two boom sections, effectively locking them together. Inducing actuator 86 to drive the wedge 91 toward the tip of base boom 12 forces the wide area of the wedge 91 to expand the snap-ring 87, releasing the locking engagement between the tip collar 51 and the base collar 29, as shown in Section A-A. Other embodiments of the present invention include one or more sliding bolts, cams, pins, a single actuator as shown in U.S. patent application Ser. No. 09/819,498, and/or other locking elements to effect a releasably locking engagement between adjacent boom sections.

The present invention is advantageous in that the extension mechanism allows for supporting and aligning each boom section during extension. More specifically, each boom section is capable of being supported, and thereby controlling motion in at least one plane, but preferably in the vertical and horizontal planes. The extension mechanism is capable of engaging and moving the boom sections parallel to the longitudinal axis of a boom section, and resisting movement of the extending boom sections about at least one axis perpendicular to the longitudinal axis of the boom section, and more preferably resisting movement about any axis perpendicular to the longitudinal axis of the boom section.

Of course, as would be understood by one of ordinary skill in the art, it is possible to form the individual column sections in varying lengths and diameters, depending upon the anticipated load capacity and the reach of the column needed. Likewise, it is possible to create the extending column from a single base column section and a single tip section. It is possible to include at least one intermediate column section or even a plurality of column sections. It will also be understood by one of ordinary skill in the art that the total length of the extending column can be configured to have as many intermediate sections as are necessary to achieve the maximum length required to suit the needs of a particular job.

Individual column sections of example embodiments of the present invention may have diameters of about 1 to 12 feet (0.3 to 3.6 m) and lengths of about 5 to 80 feet (1.5 to 24 m). It is not necessary that each of the column sections have the same length. The overall fully extended length of the extending column of example embodiments of the present invention can be from about 20 to 600 feet (6 to 180 m). Typically, the sections are roughly 6 feet (1.8 m) in diameter, 30 feet (9 m) in length, and the overall extended length (having 10 sections of the same approximate length) is about 305 feet (93 m). The configuration shown in FIG. 4 wherein four columns are joined to produce one crane boom illustrates one scale possible with the present invention. Crane boom 20 erected as shown features a boom 500 feet long and 30 feet square in cross-section. The chords are columns comprising the present invention and are nearly four feet in diameter. When fitted with an appropriate counter boom cranes of similar proportions lift over 1000 tons and take weeks to set up. The compactness, strength, and accuracy achieved with the present invention allow this massive boom to be quickly broken down, stowed and shipped with a minimal amount of time, labor and equipment required to erect again elsewhere. Of course, those skilled in the art will recognize that larger or smaller columns and column sections can be provided within the scope of the present invention.

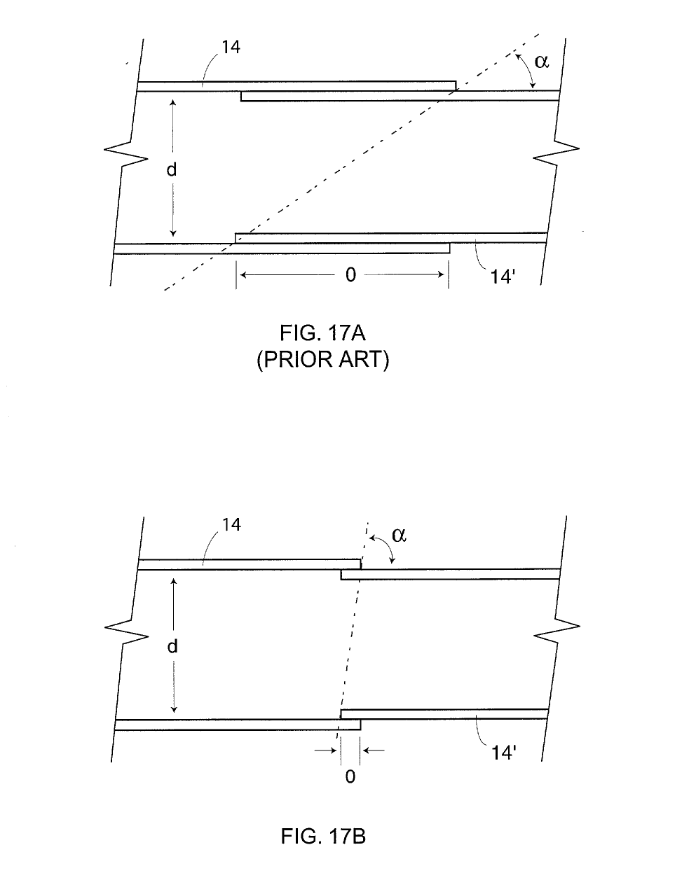

Currently available telescoping cranes typically use one or two pins to engage and retain each boom section from retracting. The boom sections are held in alignment, so that the boom is relatively straight, by overlapping about 20% of the length of each extensible boom section nested within its adjacent section. The present invention enables the elimination of this overlap of up to 20% or more of the available boom length, which heretofore has amounted to a significant amount of dead weight left retracted within the adjacent boom section. In fact, the present invention furnishes a possibility for utilizing nearly all of the available boom length. The 20% unused boom length overlap of existing cranes currently available is no longer necessary. Of the many advantages: decreased overall weight, decreased manufacturing costs, and a more rigid extended boom having less loose motion between the individual boom sections, figure prominently. For example, as seen with reference to FIG. 17a, adjacent outer and inner boom sections 14, and 14a of typical prior art telescoping booms overlap by a substantial distance O that generally exceeds the height, diameter or other major cross-sectional dimension d of the inner boom section. As a result, the support angle α (the angle between the longitudinal axis of the boom and a line or plane extending between the most proximal and most distal overlap points on opposite sides of the boom) of prior art telescoping boom sections is typically less than about 45°. By contrast, and with reference to FIG. 17b, the adjacent outer and inner boom sections 14, 14′ of the present invention overlap by a much smaller distance O that is less than the major cross-sectional dimension d of the inner boom section. As a result, the support angle α of the present invention is typically greater than about 45°, preferably greater than about 60°, more preferably greater than about 85°, and most preferably approaches 90°, such as for example about 89°.

The releasable locking mechanism according to one embodiment of the present invention not only keeps the individual boom sections from retracting within the adjacent boom section, but also locks the two boom sections in horizontal and vertical alignment. Because the individual boom sections or groups of boom sections are individually secured before the adjacent boom section is advanced, it is possible to operate the telescoping boom crane in a partially extended configuration. The telescoping boom crane according to one embodiment of the present invention includes several features which combine and cooperate to make an extremely efficient telescoping boom which can be made much longer, lighter and more rigid than currently available telescoping booms.

The terms and expressions which have been employed herein are used as terms of description and not of limitation, and there is no intention, in the use of such terms and expressions, of excluding any equivalents of the features shown and described or portions thereof.

What is claimed is:

1. A telescoping column comprising:
a first column section having proximal and distal ends, the distal end of said first column section comprising a tip collar;
a second column section telescopingly coupled to the first column section and movable between a retracted position and an extended position, the second column section comprising proximal and distal ends, the proximal end of said second column section comprising a base collar;
wherein the tip collar and the base collar are releasably engageable with one another to lock the second column section in its extended position.

2. The telescoping column of claim 1, further comprising at least a third column section telescopingly coupled to the second column section.

3. The telescoping column of claim 1, wherein the tip collar comprises a toothed inner contour comprising a plurality of teeth, each tooth separated from an adjacent tooth by a space.

4. The telescoping column of claim 3, wherein the base collar comprises a toothed outer contour comprising a plurality of teeth, each tooth separated from an adjacent tooth by a space, and wherein the toothed inner contour of the tip collar generally matches the toothed outer contour of the base collar to permit passage of the base collar at least partially through the tip collar when the base collar and the tip collar are in alignment.

5. The telescoping column of claim 4, wherein at least part of the base collar is movable out of alignment with the tip collar to lock the second column section in its extended position relative to the first column section.

6. The telescoping column of claim 5, wherein the toothed inner contour of the tip collar comprises a slot for receiving a portion of the toothed outer contour of the base collar and permitting rotation of at least part of the base collar therein.

7. The telescoping column of claim 6, wherein the slot is slightly narrower than the portion of the toothed outer contour of the base collar received therein.

8. The telescoping column of claim 5, wherein at least one of the toothed inner contour of the tip collar and the toothed outer contour of the base collar comprise a tapered surface for aligning the base collar and tip collar during locking.

9. The telescoping column of claim 4, wherein each of the first and second column sections are corrugated and comprise a plurality of alternating ridges and grooves, and wherein interior ridges and grooves of the first column section generally match the toothed inner contour of the tip collar, and exterior ridges and grooves of the second column section generally match the toothed outer contour of the base collar.

10. The telescoping column of claim 1, further comprising an extension mechanism for moving the second column section between its extended and retracted positions.

11. The telescoping column of claim 10, wherein the extension mechanism comprises a carriage translationally mounted to a track within the column.

12. The telescoping column of claim 11, wherein the extension mechanism further comprises at least one latch for engaging a cooperating portion of the second column section.

13. The telescoping column of claim 12, comprising a plurality of latches spaced about the carriage.

14. The telescoping column of claim 13, comprising four latches spaced about the carriage at right angles to one another.

15. The telescoping column of claim 12, wherein each of the at least one latch(es) is pivotally mounted to the carriage, and wherein the extension mechanism further comprises a repositioning mechanism for repositioning a portion of the column section base collar relative to the carriage.

16. The telescoping column of claim 10, wherein the extension mechanism comprises a receiving member for engaging a cooperating portion of the first or second column section.

17. The telescoping column of claim 16, wherein the extension mechanism further comprises an activation mechanism for moving the receiving member between a first position and a second position to lock and unlock the second column section in its extended position.

18. A crane comprising the column of claim 1 mounted to a base structure.

19. The crane of claim 18, comprising a tower crane having a vertical column section and a horizontal column section.

20. The crane of claim 18, further comprising a crane pendant system.

21. The crane of claim 20, wherein the crane pendant system is an extensible crane pendant system.

22. A telescoping column comprising:
a first column section; and
a second column section telescopingly coupled to the first column section and movable between a retracted position and an extended position;
wherein the first and second column sections overlap in the extended position by a distance less than a major cross sectional dimension of the column.

23. A telescoping column comprising:
a first column section; and
a second column section telescopingly coupled to the first column section and movable between a retracted position and an extended position;
wherein the first and second column sections define a support angle greater than 45° in the extended position.

24. The telescoping column of claim 23, wherein the first and second column sections define a support angle of at least about 60° in the extended position.

25. The telescoping column of claim 23, wherein the first and second column sections define a support angle of about 85° in the extended position.

26. The telescoping column of claim 23, wherein the first and second column sections define a support angle of about 89° in the extended position.

27. The telescoping column of claim 23, wherein the first and second column sections define a support angle of about 90° in the extended position.

28. A locking mechanism for locking adjacent sections of a telescoping column in position relative to one another, comprising:
a female locking ring having an irregular inner contour; and
a male locking ring having an irregular outer contour, wherein the irregular outer contour of the male locking ring can pass at least partially through the irregular inner contour of the female locking ring in an aligned configuration, but wherein the irregular outer contour of the male locking ring can not be retracted from the irregular inner contour of the female locking ring in an unaligned configuration;
wherein at least one of the male and female locking rings moves between the aligned configuration and the unaligned configuration.

29. The locking mechanism of claim 28, wherein the female locking ring is mounted to a distal end of a first column section, and the male locking ring is mounted to a proximal end of a second column section telescopingly mounted within the first column section.

30. The locking mechanism of claim 28, wherein the irregular inner contour of the female locking ring comprises a slot for receiving a portion of the irregular outer contour of the male locking ring and permitting rotation of the male locking ring therein.

31. The locking mechanism of claim 30, wherein the slot is slightly narrower than the portion of the outer contour of the male locking ring received therein.

32. The locking mechanism of claim 28, wherein said irregular inner and outer contours each comprise a plurality of teeth, each tooth separated by a space from an adjacent tooth.

33. The locking mechanism of claim 32, wherein the teeth of at least one of the inner and outer contours comprise a tapered surface.

34. The locking mechanism of claim 28, wherein at least one of said male and female locking rings comprise a handle for engagement by an activation mechanism to move the locking rings relative to one another between the aligned configuration and the unaligned configuration.

35. An extension mechanism for moving a telescoping section of a column between a retracted position and an extended position, comprising:
a track mounted within the column;
a carriage translationally mounted to said track, and movable between a loading position and a locking position; and
a latch mounted to said carriage, said latch arranged to engage said telescoping section and support the section during extension along a longitudinal axis.

36. The extension mechanism of claim 35, wherein said at least one latch supports the telescoping section against rotation about a first axis perpendicular to said longitudinal axis during extension.

37. The extension mechanism of claim 36, wherein said at least one latch supports the telescoping section against rotation about a second axis perpendicular to both said longitudinal axis and said first axis during extension.

38. The extension mechanism of claim 35, comprising a plurality of latches spaced about the carriage.

39. The extension mechanism of claim 35, comprising four latches spaced about the carriage at right angles to one another.

40. The extension mechanism of claim 35, wherein each of the at least one latch(es) is pivotally mounted to the carriage.

41. The extension mechanism of claim 40, further comprising at least one spring for biasing each of the at least one latch(es) away from the carriage.

42. The extension mechanism of claim 41, further comprising a repositioning mechanism for pivoting the latch(es) toward the carriage.

43. The extension mechanism of claim 35, wherein each of the at least one latch(es) comprises a notch for engaging a cooperating collar of the telescoping section.

44. The extension mechanism of claim 35, further comprising a receiving member for engaging a cooperating portion of the telescoping section.

45. The extension mechanism of claim 44, further comprising an activation mechanism for moving the receiving member between a first position and a second position to lock and unlock the telescoping section in its extended position.

46. The extension mechanism of claim 35, further comprising drive means for moving the carriage between the loading position and the locking position.

47. A method of locking first and second sections of a telescoping column in a fixed position relative to one another, said method comprising:
aligning a first locking element of the first section with a cooperating second locking element of the second section;
positioning the first and second sections in a desired position relative to one another; and
moving the first locking element out of alignment with the second locking element to prevent relative movement between the first and second sections.

48. A crane comprising:
a support base;
a telescoping column comprising a first column section mounted to the support base and at least one telescoping column section telescopingly coupled to the first column section;
an extension mechanism comprising a track within the column, a carriage translationally mounted to the track, and at least one latch pivotally mounted to the carriage for engaging a portion of the at least one telescoping column section; and
a locking mechanism comprising a first locking ring mounted to the first column section and having an irregular inner contour, and a second locking ring mounted to the telescoping column section and having an irregular outer contour.
